(19) United States
(12) Patent Application Publication
(10) Pub. No.: US 2023/0339507 A1
(43) Pub. Date: Oct. 26, 2023

(54) CONTEXTUAL RIGHT-OF-WAY DECISION MAKING FOR AUTONOMOUS VEHICLES

(71) Applicant: GM CRUISE HOLDINGS LLC, SAN FRANCISCO, CA (US)

(72) Inventors: Sasanka Nagavalli, Cupertino, CA (US); Nenad Uzunovic, San Carlos, CA (US); Ashish Bhatnagar, Redwood City, CA (US)

(73) Assignee: GM CRUISE HOLDINGS LLC, SAN FRANCISCO, CA (US)

(21) Appl. No.: 17/724,661

(22) Filed: Apr. 20, 2022

(51) Int. Cl. B60W 60/00; B60W 40/04

(52) U.S. Cl. CPC B60W 60/0015; B60W 40/04; B60W 60/0011; B60W 2554/4026; B60W 2554/4029

(57) ABSTRACT

Approaches to utilizing contextual right-of-way decision making for autonomous vehicles are disclosed. An autonomous vehicle is operated in a road setting within an operating environment having other road users. The operation of the autonomous vehicle is based on safety constraints providing limits on operation of the autonomous vehicle. The presence of a selected other road user within the operating environment is detected. Potential trajectories for the autonomous vehicle within the operating environment are evaluated with respect to the other road user. The autonomous vehicle interacts with the other road user by generating vehicle control signals based on a machine learned model and within the one or more safety constraints. The machine learned model is based on a hierarchy of costs corresponding to characteristics of maneuvers by the autonomous vehicle.

### TECHNICAL FIELD

Examples provided herein relate to control of autonomous vehicles operating in driving environments also having human-operated vehicles. More particularly, examples provided herein relate to use of machine learning techniques with yield/assert decisions when operating around other vehicles including human-operated vehicles.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an example autonomous vehicle.

FIG. 2A illustrates an example road situation in which an autonomous vehicle can yield to another vehicle or overtake the other vehicle.

FIG. 2B illustrates an example road situation in which another vehicle trails an autonomous vehicle.

FIG. 3 illustrates an example road situation in which an autonomous vehicle interacts with a pedestrian.

FIG. 4 is a block diagram of an example control system that can manage contextual right-of-way evaluations for an autonomous vehicle.

FIG. 5 is a flow diagram for one technique for contextual right-of-way evaluations for an autonomous vehicle.

FIG. 6 is a block diagram of one example of a processing system that can provide contextual right-of-way evaluations for an autonomous vehicle.

### DETAILED DESCRIPTION

With the examples provided below, control mechanisms of an autonomous vehicle can utilize machine learning (ML) techniques to determine if the autonomous vehicle should yield or assert (i.e., not yield to other road users) while maintaining existing safety constraints. Conceptually, this can be referred to as a contextual right of way (CRoW), which can address whether the autonomous vehicle should yield to another road user or overtake (not yield) to the other road user. The other road users can include, for example, other autonomous vehicles, human-operated vehicles, bicycles, pedestrians, etc.

The architectures and techniques described below provide the ability to combine hard constraints for autonomous vehicle limits and safety concerns with a machine learned (ML) model that can provide more human-like yield/assert decisions. The machine learned model(s) can provide context to decisions based on hard constraints, which can result in a contextual maneuver (e.g., yield/assert) decision by the autonomous vehicle control systems.

Hard constraints refer to specific values and/or parameters that guide the operation of the autonomous vehicle and are not violated during operation. For example, a maximum top speed is the highest allowable speed for the autonomous vehicle, and the autonomous vehicle will not exceed the maximum top speed. Other example hard constraints can include vehicle payload, distance to other vehicles while parking, etc.

In an example, the autonomous vehicle safety constraints (e.g., emergency stops, collision avoidance, maximum speed and other physics-based limits) are unaffected by the machine learning models. Thus, outer bounds are maintained. In an example, the use of the machine learned model for a traffic maneuver (e.g., yield/assert situations) can be varied based on, for example, proximity to other road users, geometric features of the operating environment (e.g., intersection geometry, curbs, hard medians, drivable area, crosswalks), semantic features of the operating environment (e.g., traffic controls like stop lines, yield signs, legal speed limits, time-of-day restrictions, school zones, traffic light states), current state of the autonomous vehicle, predicted future motion of other road users, state of other road users (e.g., turn signals, open doors, agent type [car, bike, pedestrian]), etc. This can provide deterministic control of lawful and safe decisions with more human-like behavior overall.

In an example, the yield/assert determination can be based on a hierarchy of costs where yield probabilities can be translated into corresponding costs with a machine learning model and utilized as one of several costs used in decision making.

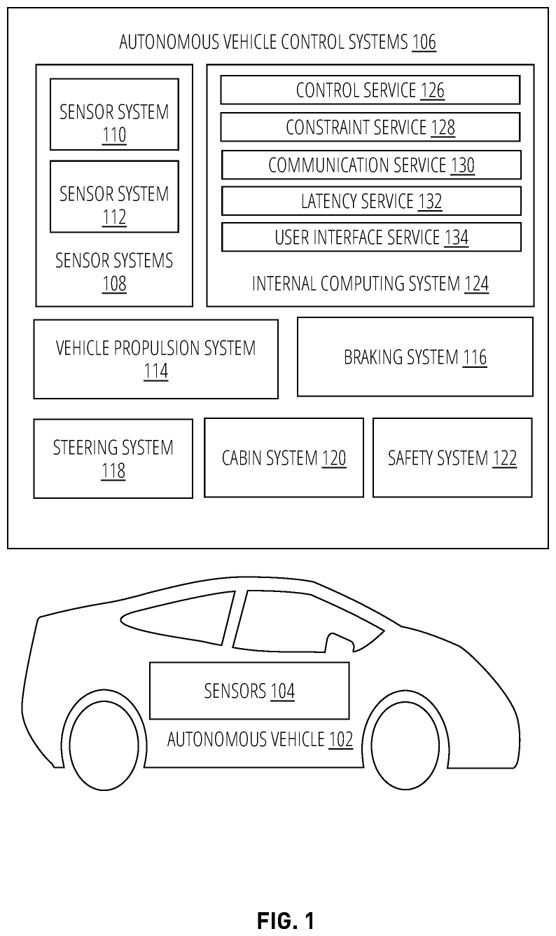

FIG. 1 is a block diagram of an example autonomous vehicle. Autonomous vehicle 102 has the functionality to navigate roads without a human driver by utilizing sensors 104 and autonomous vehicle control systems 106. Autonomous vehicle 102 can be configured to operate utilizing the machine learning based contextual decision making processes described below.

Autonomous vehicle 102 can include, for example, sensor systems 108 including any number of sensor systems (e.g., sensor system 110, sensor system 112). Sensor systems 108 can include various types of sensors that can be arranged throughout autonomous vehicle 102. For example, sensor system 110 can be a camera sensor system. As another example, sensor system 112 can be a light detection and ranging (LIDAR) sensor system. As a further example, one of sensor systems 108 can be a radio detection and ranging (RADAR) sensor system, an electromagnetic detection and ranging (EmDAR) sensor system, a sound navigation and ranging (SONAR) sensor system, a sound detection and ranging (SODAR) sensor system, a global navigation satellite system (GNSS) receiver system, a global positioning system (GPS) receiver system, accelerometers, gyroscopes, inertial measurement unit (IMU) systems, infrared sensor systems, laser rangefinder systems, microphones, etc.

Autonomous vehicle 102 can further include mechanical systems to control and manage motion of autonomous vehicle 102. For example, the mechanical systems can include vehicle propulsion system 114, braking system 116, steering system 118, cabin system 120 and safety system 122. Vehicle propulsion system 114 can include, for example, an electric motor, an internal combustion engine, or both. Braking system 116 can include an engine brake, brake pads, actuators and/or other components to control deceleration of autonomous vehicle 102. Steering system 118 can include components that control the direction of autonomous vehicle 102. Cabin system 120 can include, for example, cabin temperature control systems, in-cabin infotainment systems and other internal elements.

Safety system 122 can include various lights, signal indicators, airbags, systems that detect and react to other vehicles. Safety system 122 can include one or more radar systems. Autonomous vehicle 102 can utilize different types of radar systems, for example, long-range radar (LRR), mid-range radar (MRR) and/or short-range radar (SRR). LRR systems can be used, for example, to detect objects that are farther away (e.g., 200 meters, 300 meters) from the vehicle transmitting the signal. LRR systems can operate in the 77 GHz band (e.g., 76-81 GHz). SRR systems can be used, for example, for blind spot detection or collision avoidance. SRR systems can operate in the 24 GHz band. MRR systems can operate in either the 24 GHz band or the 77 GHz band. Other frequency bands can also be supported.

Autonomous vehicle 102 can further include internal computing system 124 that can interact with sensor systems 108 as well as the mechanical systems (e.g., vehicle propulsion system 114, braking system 116, steering system 118, cabin system 120 and safety system 122). Internal computing system 124 includes at least one processor and at least one memory system that can store executable instructions to be executed by the processor. Internal computing system 124 can include any number of computing sub-systems that can function to control autonomous vehicle 102. Internal computing system 124 can receive inputs from passengers and/or human drivers within autonomous vehicle 102.

Internal computing system 124 can include control service 126, which functions to control operation of autonomous vehicle 102 via, for example, the mechanical systems as well as interacting with sensor systems 108. Control service 126 can interact with other systems (e.g., constraint service 128, communication service 130, latency service 132 and internal computing system 124) to control operation of autonomous vehicle 102.

Internal computing system 124 can also include constraint service 128, which functions to control operation of autonomous vehicle 102 through application of rule-based restrictions or other constraints on operation of autonomous vehicle 102. As described in greater detail below, constraint service 128 can provide hard constraints on one or more movements of autonomous vehicle 102 and the machine learned models can operate within those constraints to provide more sophisticated decisions on proposed actions (e.g., yield vs. no-yield) without undermining the safety provided by constraint service 128. Constraint service 128 can interact with other systems (e.g., control service 126, communication service 130, latency service 132, user interface service 134) to control operation of autonomous vehicle 102.

Internal computing system 124 can further include communication service 130, which functions to control transmission of signals from, and receipt of signals by, autonomous vehicle 102. Communication service 130 can interact with safety system 122 to provide the waveform sensing, amplification and repeating functionality described herein. Communication service 130 can interact with other systems (e.g., control service 126, constraint service 128, latency service 132 and user interface service 134) to control operation of autonomous vehicle 102.

Internal computing system 124 can also include latency service 132, which functions to provide and/or utilize timestamp information on communications to help manage and coordinate time-sensitive operations within internal computing system 124 and autonomous vehicle 102. Thus, latency service 132 can interact with other systems (e.g., control service 126, constraint service 128, communication service 130, user interface service 134) to control operation of autonomous vehicle 102.

Internal computing system 124 can further include user interface service 134, which functions to provide information to, and receive inputs from, human passengers within autonomous vehicle 102. This can include, for example, receiving a desired destination for one or more passengers and providing status and timing information with respect to arrival at the desired destination. User interface service 134 can interact with other systems (e.g., control service 126, constraint service 128, communication service 130, latency service 132) to control operation of autonomous vehicle 102.

Internal computing system 124 can function to send and receive signals from autonomous vehicle 102 regarding reporting data for training and evaluating machine learning algorithms, requesting assistance from a remote computing system or a human operator, software updates, rideshare information (e.g., pickup and/or dropoff requests and/or locations), etc.

In operation, autonomous vehicle 102 can follow a trajectory selected by internal computing system 124. To follow the selected trajectory, internal computing system 124 can send control signals to one or more systems (e.g., vehicle propulsion system 114, braking system 116, steering system 118, cabin system 120, safety system 122) to control the kinematic and dynamic behaviors of autonomous vehicle 102.

In some examples described herein autonomous vehicle 102 (or another device) may be described as collecting data corresponding to surrounding vehicles. This data may be collected without associated identifiable information from these surrounding vehicles (e.g., without license plate numbers, make, model, and the color of the surrounding vehicles). Accordingly, the techniques mentioned here can be used for the beneficial purposes described, but without the need to store potentially sensitive information of the surrounding vehicles.

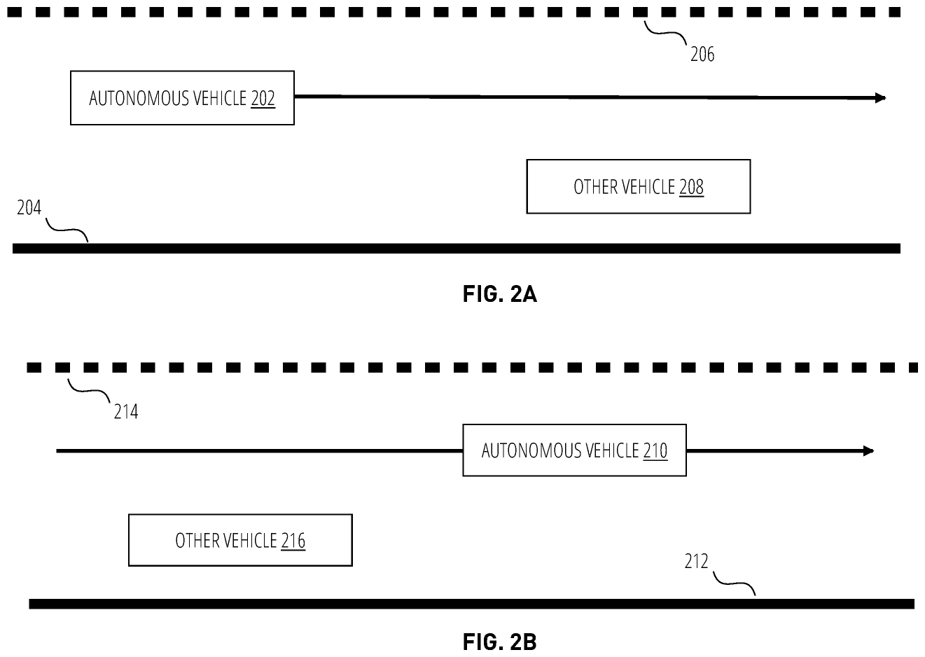

FIG. 2A illustrates an example road situation in which an autonomous vehicle can yield to another vehicle or overtake the other vehicle. FIG. 2A is a simple example of an autonomous vehicle operating environment. In the example of FIG. 2A, autonomous vehicle 202 is traveling in a lane defined by solid line 204 and dashed line 206. Other vehicle 208 is also in the lane.

If autonomous vehicle 202 is traveling at a higher rate of speed than other vehicle 208, autonomous vehicle 202 must either yield to other vehicle 208 by slowing down and staying behind other vehicle 208, or autonomous vehicle 202 must overtake other vehicle 208. Autonomous vehicle 202 can utilize various control mechanisms and techniques described in greater detail below to determine whether to continue to follow other vehicle 208 or to overtake other vehicle 208.

FIG. 2B illustrates an example road situation in which another vehicle trails an autonomous vehicle. FIG. 2B is a simple example of an autonomous vehicle operating environment. In the example of FIG. 2B, autonomous vehicle 210 is traveling in a lane defined by solid line 212 and dashed line 214. Other vehicle 216 is also in the lane.

The situation as illustrated in FIG. 2B can be a continuation of the situation as illustrated in FIG. 2A where autonomous vehicle 210 has passed other vehicle 216. Alternatively, the situation as illustrated in FIG. 2B can be one where other vehicle 216 is traveling at a higher rate of speed than autonomous vehicle 210 and closing on autonomous vehicle 210. Autonomous vehicle 210 can utilize various control mechanisms and techniques described in greater detail below to determine how to interact with other vehicle 216.

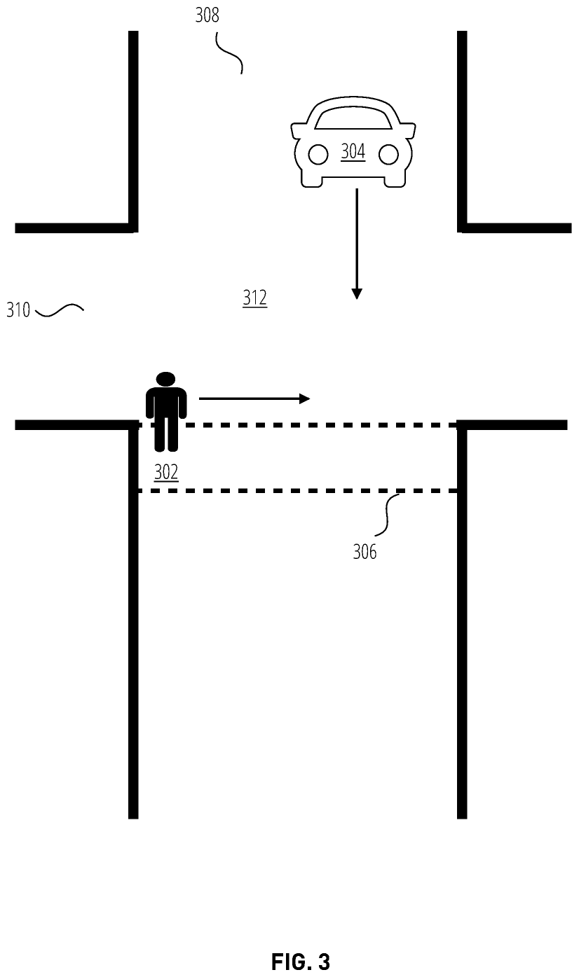

FIG. 3 illustrates an example road situation in which an autonomous vehicle interacts with a pedestrian. In the example of FIG. 3, autonomous vehicle 304 is traveling in major road 308 that intersects with minor road 310 at intersection 312. Other road users (not illustrated in FIG. 3) can also be in the operating environment.

A minor-major intersection is an intersection where a vehicle (e.g., an autonomous vehicle) entrance into the intersection is controlled by a stop sign or by a yield sign, and the cross traffic lanes do not stop (e.g., do not have a traffic control mechanism that requires a stop at the intersection). The lane with the stop sign or yield sign is considered the minor and the cross-traffic lanes that do not stop and have the right of way are considered the major. Minor-major maneuvers can be considered unprotected because the traffic on the minor road must yield to the traffic on the major road.

There are various types of minor-major maneuvers that can be differentiated by one or more characteristics including, for example, turn type, traffic sign type, speed limit of outgoing lane, number of outgoing lanes with same turn direction, road topology and sidewalk crossing. Additional and/or different characteristics can be utilized.

Pedestrian 302 is crossing major road 308 within crosswalk 306. When autonomous vehicle 304 detects pedestrian 302, one or more control systems of autonomous vehicle 304 (e.g., autonomous vehicle control systems 106 of autonomous vehicle 102) determine how to interact with pedestrian 302. In the example of FIG. 3, autonomous vehicle 304 is moving toward crosswalk 306 and pedestrian 302 is beginning to move across crosswalk 306.

In an example, autonomous vehicle 304 can yield to pedestrian 302 by slowing down and/or stopping for pedestrian 302 before they cross the intended travel path of autonomous vehicle 304, or autonomous vehicle 304 can assert by moving across the intended travel path of pedestrian 302. The determination to yield or assert by autonomous vehicle 304 can be based on various factors including, for example, based on a hierarchy of costs where yield probabilities can be translated into corresponding costs with a machine learning model and utilized as one of several costs used in decision making.

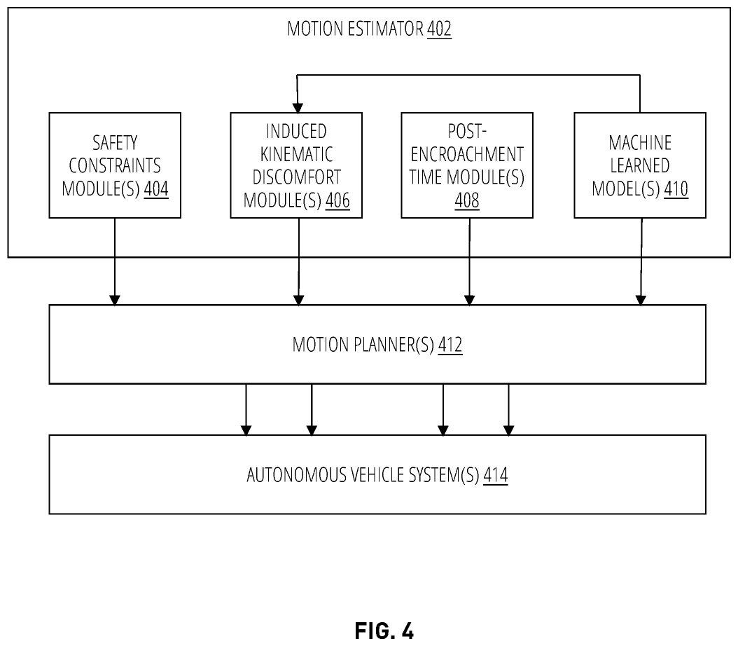

FIG. 4 is a block diagram of an example control system that can manage contextual right-of-way evaluations for an autonomous vehicle. The elements of the example control system of FIG. 4 can be, for example, part of internal computing system 124 of autonomous vehicle 102.

In the example of FIG. 4, motion estimator 402 can include one or more of safety constraints module(s) 404, induced kinematic discomfort module(s) 406, post-encroachment time module(s) 408 and machine learned model(s) 410. Motion estimator 402 can generate or evaluate one or more proposed trajectories for the autonomous vehicle. The proposed trajectories can be in response to sensor information from various systems (e.g., RADAR system, LIDAR system, camera system, maps, global positioning system) that provide information about the operating environment.

One or more of the modules and/or models of motion estimator 402 can provide cost values associated with the one or more proposed trajectories. In an example, the proposed trajectories have an associated limited planning horizon, which can be a spatial planning horizon, a temporal planning horizon or a combination thereof.

Safety constraints module(s) 404 can provide hard safety constraints for various systems of the host autonomous vehicle including, for example, a propulsion system, a braking system, a steering system, a safety system and/or a cabin system, etc. Each system can have one or more corresponding constraints. For example, the propulsion system can have a speed limit and/or acceleration limit. As another example, the steering system can have a steering angle limit as a function of vehicle speed and/or acceleration. Many other safety constraints and limits can be implemented. Various safety constraints can be provided to motion planner(s) 412.

In general, kinematics is the geometry of motion and the various related characteristics include, for example, acceleration/deceleration, velocity, position, relative motion, etc. As used herein, induced kinematic discomfort refers to discomfort caused by an autonomous vehicle (e.g., autonomous vehicle 102) on another road user as a result of the other road user changing a kinematic characteristic in response to an action taken by the autonomous vehicle. For example, if the autonomous vehicle makes a right turn and causes another road user to use a braking system to decelerate in response to the right turn, the kinematic changes to the other road user are the induced kinematic discomfort of the right turn. The induced kinematic discomfort can be treated as a cost in an evaluation of available trajectories or paths that the autonomous vehicle may take. Some induced kinematic discomfort may be acceptable, while induced kinematic discomfort over some threshold amount may be considered excessive and unacceptable. In some examples, increased induced kinematic discomfort results in increased cost for the corresponding autonomous vehicle maneuver.

Induced kinematic discomfort module(s) 406 can estimate various kinematic effects of the proposed trajectories analyzed by motion estimator 402. In an example, induced kinematic discomfort module(s) 406 can generate an induced kinematic discomfort cost associated with one or more of the proposed trajectories. In another example, induced kinematic discomfort module(s) 406 can generate an induced kinematic discomfort cost for individual maneuvers within the proposed trajectories.

In an example, the induced kinematic discomfort cost includes a yield probability component that is derived from a contextual right-of-way (CRoW) model from machine learned model(s) 410. In an example, yield probability captures two different types of uncertainty: (a) real world ambiguity representing uncertainty in the binary decision of whether it is actually acceptable to overtake another agent or not; and (b) model confidence in the prediction of such a decision.

In an example, induced kinematic discomfort has two components (as discussed above) and the higher value of the two components can be used for the yield/assert decision. For example, if induced braking on another road user results in a higher cost value than the CRoW model, the induced kinematic discomfort cost is set to the induced braking component. If the CRoW model component is higher than the braking component, the induced kinematic discomfort cost is set to the CRoW component. In an example, the induced kinematic discomfort from the yield probability is additive, thus increases the cost of the corresponding trajectory/maneuver.

Conceptually, the general idea to augment the physics-based portion of the induced kinematic discomfort cost with reasoning about the probability (obtained from a ML model) that the autonomous vehicle should yield to another road user, so that the induced kinematic discomfort cost is higher when autonomous vehicle should yield to the other road user and lower when it is not necessary for autonomous vehicle to yield to the other road user.

In an example, another cost that can be considered is the lateral buffer for a road user other than the one for which the yield/assert decision is being evaluated that can be modulated by the yield/assert probability. These other road users can be referred to as non-playable characters or non-playing characters (NPCs). In an example, when a confidence level associated with a yield/assert decision increases a smaller buffer can be maintained as compared to when uncertainty is greater (e.g., 50/50 split) whether the autonomous vehicle should assert or yield. The costs associated with the induced kinematic discomfort can be provided to motion planner(s) 412.

Post-encroachment time refers to an evaluation of trajectories for two or more vehicles, where those trajectories intersect and how much of a time gap is allowed between trajectory intersections. Thus, post-encroachment time is generally how much travel time (e.g., following distance) will result after the autonomous vehicle executes the desired maneuver. For example, if the autonomous vehicle makes a right turn, the post-encroachment time corresponds to how much following distance (in terms of a time gap) is allowed to another road user that is following the autonomous vehicle after the right turn.

Post-encroachment time module(s) 408 can estimate and assign various costs associated with the proposed trajectories analyzed by motion estimator 402 in terms of following distance and/or other time gaps resulting from executing the proposed trajectories. The post-encroachment time costs can be determined in terms of trajectories and/or in terms of individual maneuvers within the proposed trajectories. The costs estimated by post-encroachment time module(s) 408 can be provided to motion planner(s) 412.

Machine learned model(s) 410 can be one or more models generated using machine learning techniques. One or more models can be trained using, for example, recorded road data from previous trips in the same area. Various machine learning techniques, for example, supervised machine learning and/or unsupervised machine learning techniques can be utilized. Various factors (e.g., proximity to stop signs, intersections, crosswalks) can be utilized for training including, for example, kinematics of the autonomous vehicle, kinematics of one or more other road users, locations of other road users, presence of emergency vehicles, detection of emergency flashers, autonomous vehicle speed, autonomous vehicle location. Additional and/or different factors can also be used in training machine learned models.

In an example, one or more of machine learned model(s) 410 can be auto-tuned models. In an example, machine learned model(s) 410 can also provide one or more heuristics to guide motion planner(s) 412 in generation of the final trajectory. Thus, in some examples, motion planner(s) 412 can apply heuristics while also utilizing model-based strategies.

Motion planner(s) 412 receives cost and other information from safety constraints module(s) 404, induced kinematic discomfort module(s) 406, post-encroachment time module(s) 408 and machine learned model(s) 410 to evaluate one or more of the proposed trajectories and generate a final trajectory. In an example, the final trajectory generated by motion planner(s) 412 can be a higher-resolution trajectory as compared to the proposed trajectories from motion estimator 402. For example, the final trajectory may have associated with it more detailed maneuver information (e.g., speed, acceleration, turning radius, braking) that can be executed by the various components of the autonomous vehicle.

In an example, motion planner(s) 412 can utilize a hierarchy of costs to evaluate the proposed trajectories and generate the final trajectory. The hierarchy of costs can be based on, for example, safety (e.g., time to collision), comfort (e.g., distance from others and/or relative change in kinematics) and/or other relevant factors. In an example, different costing strategies can be used for different situations (e.g., autonomous vehicle following other road user as in FIG. 2A, autonomous vehicle leading the other road user as in FIG. 2B). As further examples, different costing strategies can be applied for different regions of travel, or for different types of other road users, or for weather conditions or time of day, etc. Selection of the costing strategy can be based on a machine learned model from machine learned model(s) 410. Motion planner(s) 412 can select the final trajectory based on cost evaluations (including machine learned model information) within specified ranges (e.g., comfort).

In an example, motion planner(s) 412 can utilize one or more of hard safety constraints, dynamic costing strategies based on induced kinematic discomfort costs and post-encroachment time costs, one or more heuristics and/or one or more machine learned models, to make various decisions with respect to autonomous vehicle trajectories (or changes to autonomous vehicle trajectories). Use of this more sophisticated strategy can provide a more predictable (to other road users) and/or more human-like operation of the autonomous vehicle.

Autonomous vehicle system(s) 414 can receive the final trajectory from motion planner(s) 412 and cause the various systems (e.g., propulsion system, braking system, steering system, safety system and/or cabin system) of the autonomous vehicle to execute the final trajectory. This can be, for example, yielding to another road user, or asserting (e.g., overtaking) another road user.

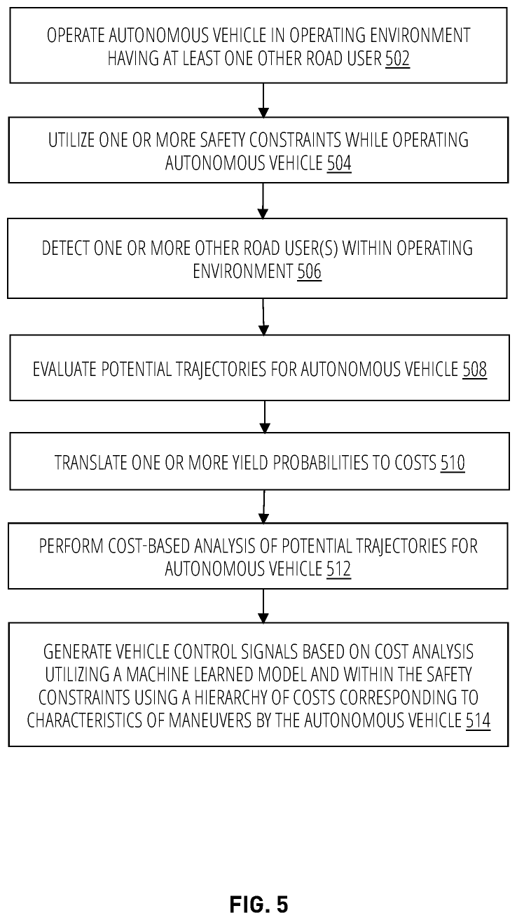

FIG. 5 is a flow diagram for one technique for contextual right-of-way evaluations for an autonomous vehicle. The navigation techniques as described with respect to FIG. 5 can be performed by, for example, autonomous vehicle 102 utilizing one or more of sensors 104 and autonomous vehicle control systems 106.

The autonomous vehicle (e.g., autonomous vehicle 102, autonomous vehicle 202, autonomous vehicle 210) can be operated in an operating environment (e.g., FIG. 2A, FIG. 2B) having at least one other road user (e.g., other vehicle 208, other vehicle 216), 502. During operation, one or more hard safety constraints can be utilized to keep operation of the autonomous vehicle within appropriate operating parameters, 504.

One or more other road users are detected within the operating environment, 506. This can be accomplished by, for example, RADAR sensor systems, LIDAR sensor systems, cameras, etc. The other road users can be, for example, another autonomous vehicle, a human-operated vehicle (e.g., car, truck, bus, van), a bicycle, a pedestrian, etc. The other road users can cause situations in which the autonomous vehicle determines whether to make adjustments in the current trajectory (e.g., in terms of speed, direction, following distance) in response to actions by the other road users.

The various operations of FIG. 5 are illustrated as sequential; however, some operations may be performed in a different order and/or some operations may be performed in parallel. Thus, the example of FIG. 5 is just one approach that can utilize the advantageous concepts described herein and other configurations of operation can also utilize these advantageous concepts.

Various potential trajectories for the autonomous vehicle can be evaluated, 508. The potential trajectories can be in response to road conditions (e.g., curves, potholes, stop signs, crosswalks, change in slope), proximity of other road users (e.g., other vehicles, pedestrians), emergency vehicles, speed limit changes, etc.

Based on, for example, other road users in the operating environment and the various potential trajectories for the autonomous vehicle, conditions may exist under which a yield/assert decision will be made. In an example, probabilities associated with each potential trajectory and the corresponding yield decisions can be translated into costs, 510.

A cost-based analysis can be performed to evaluate the potential trajectories, including the yield/assert decisions, to select a trajectory for the autonomous vehicle, 512. In an example, the cost-based analysis can include at least the yield/assert decision, induced kinematic discomfort and/or post-encroachment time. Alternatively one or more of yield/assert decision, induced kinematic discomfort and post-encroachment time can be combined with other factors to provide a cost-based analysis.

For example, the induced kinematic discomfort cost component of the yield/assert decision cost-based analysis can utilize a machine learned model that causes the calculation of the induced kinematic discomfort cost to choose the correct trajectory for execution (e.g., the costs, including induced kinematic discomfort costs, are done so in a way that the lowest cost trajectory is similar to what a human would decide to do).

The vehicle control signals necessary to executed maneuvers corresponding to the selected trajectory are generated, 514 to cause the autonomous vehicle perform the maneuvers. The control signals cause the various autonomous vehicle control systems (e.g., vehicle propulsion system 114, braking system 116, steering system 118, cabin system 120, safety system 122) to operate within the hard safety constraints of the control system, with a cost-based analysis that can utilize the machine learned model(s) to function within the hard safety constraints to cause the autonomous vehicle to operate more like a human-operated vehicle.

In an example, the control signals for one or more of the autonomous vehicle control systems behave in a non-linear manner in response to machine learned models that are trained based on observation of other vehicles. This allows the autonomous vehicle to behave more like the surrounding vehicles that would otherwise be possible, which can cause the autonomous vehicle to operate in a more consistent and expected manner in the local environment.

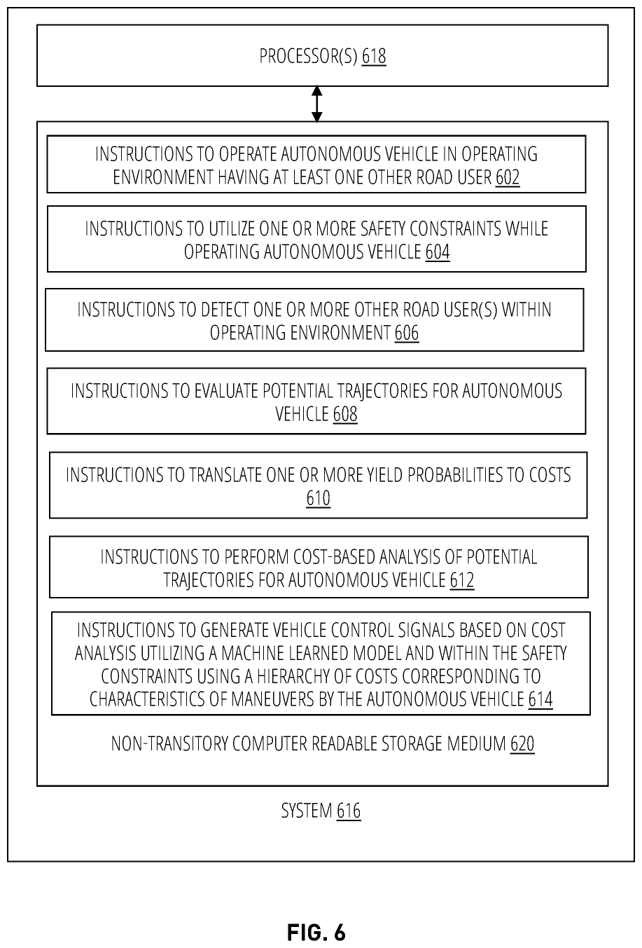

FIG. 6 is a block diagram of one example of a processing system that can provide contextual right-of-way evaluations for an autonomous vehicle. In one example, system 616 can be part of an autonomous vehicle (e.g., autonomous vehicle 102 as part of internal computing system 124) that utilizes various sensors including radar sensors. In other examples, system 616 can be part of a human-operated vehicle having an advanced driver assistance system (ADAS) that can utilized various sensors including radar sensors.

In an example, system 616 can include processor(s) 618 and non-transitory computer readable storage medium 620. Non-transitory computer readable storage medium 620 may store instructions 602, 604, 606, 608, 610 and 612 that, when executed by processor(s) 618, cause processor(s) 618 to perform various functions. Examples of processor(s) 618 may include a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of a non-transitory computer readable storage medium 620 include tangible media such as random access memory (RAM), read-only memory (ROM), electrically erasable programmable read-only memory (EEPROM), flash memory, a hard disk drive, etc.

Instructions 602 cause processor(s) 618 to cause the autonomous vehicle (e.g., autonomous vehicle 102, autonomous vehicle 202, autonomous vehicle 210) can be operated in an operating environment (e.g., FIG. 2A, FIG. 2B) having at least one other road user (e.g., other vehicle 208, other vehicle 216).

Instructions 604 cause processor(s) 618 to maintain one or more hard safety constraints during operation of the autonomous vehicle to keep the autonomous vehicle within appropriate operating parameters.

Instructions 606 cause processor(s) 618 to detect one or more other road users within the operating environment. This can be accomplished by, for example, RADAR sensor systems, LIDAR sensor systems, cameras, etc. The other road users can be, for example, another autonomous vehicle, a human-operated vehicle (e.g., car, truck, bus, van), a bicycle, a pedestrian, etc. The other road users can cause situations in which the autonomous vehicle determines whether to make adjustments in the current trajectory (e.g., in terms of speed, direction, following distance) in response to actions by the other road users.

The various operations of FIG. 6 are illustrated as sequential; however, some operations may be performed in a different order and/or some operations may be performed in parallel. Thus, the example of FIG. 6 is just one approach that can utilize the advantageous concepts described herein and other configurations of operation can also utilize these advantageous concepts.

Instructions 608 cause processor(s) 618 to evaluate various potential trajectories for the autonomous vehicle. Instructions 610 cause processor(s) 618 to translate probabilities associated with each potential trajectory and the corresponding yield decisions into costs.

Instructions 612 cause processor(s) 618 to perform a cost-based analysis to evaluate the potential trajectories, including the yield/assert decisions, to select a trajectory for the autonomous vehicle. In an example, the cost-based analysis can include at least the yield/assert decision, induced kinematic discomfort and/or post-encroachment time. Alternatively one or more of yield/assert decision, induced kinematic discomfort and post-encroachment time can be combined with other factors to provide a cost-based analysis.

Instructions 614 cause processor(s) 618 to generate the vehicle control signals necessary to execute maneuvers corresponding to the selected trajectory, which cause the autonomous vehicle perform the maneuvers. The control signals cause the various autonomous vehicle control systems (e.g., vehicle propulsion system 114, braking system 116, steering system 118, cabin system 120, safety system 122) to operate within the hard safety constraints of the control system, with a cost-based analysis that can utilize the machine learned model(s) to function within the hard safety constraints to cause the autonomous vehicle to operate more like a human-operated vehicle.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 620 has stored thereon data representing sequences of instructions that, when executed by a processor(s) 618, cause the processor(s) 618 to perform certain operations.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. A non-transitory computer-readable medium having stored thereon instructions that, when executed by one or more processors, are configurable to cause the processors to:
operate an autonomous vehicle in a road setting in an operating environment having other road users, wherein the operation of the autonomous vehicle is based, at least in part, on one or more safety constraints providing limits on operation of the autonomous vehicle;
detect the presence of a selected other road user from the other road users within the operating environment;
evaluate one or more potential trajectories for the autonomous vehicle within the operating environment with respect to the selected other road user using at least a cost-based analysis having a machine learned model, wherein the evaluation is based on a hierarchy of costs corresponding to characteristics of maneuvers by the autonomous vehicle; and
cause the autonomous vehicle to interact with the selected other road user by generating vehicle control signals based on cost-based analysis and within the one or more safety constraints.

2. The non-transitory computer-readable medium of claim 1, further comprising instructions that, when executed by the one or more processors, are configurable to cause the processors to translate yield probabilities between the autonomous vehicle and the other selected road user to costs to be utilized as part of the evaluation of the one or more potential trajectories for the autonomous vehicle within the operating environment with respect to the selected other road user.

3. The non-transitory computer-readable medium of claim 1, wherein the other road users comprise one or more of: a human-operated vehicle, another autonomous vehicle, a pedestrian, a bicycle, and a streetcar.

4. The non-transitory computer-readable medium of claim 1, wherein the interaction between the autonomous vehicle and the selected other road user comprises a yield/assert decision.

5. The non-transitory computer-readable medium of claim 4, wherein a yield probability associated with the yield/assert decision is based on a non-linear relationship between an assert decision by the autonomous vehicle and one or more characteristics of the selected other road user.

6. The non-transitory computer-readable medium of claim 1, wherein the evaluation of the one or more potential trajectories for the autonomous vehicle within the operating environment with respect to the selected other road user is performed utilizing a cost-based analysis considering at least safety factors and comfort factors.

7. The non-transitory computer-readable medium of claim 6, wherein the comfort factors comprise at least induced kinematic discomfort and post-encroachment time.

8. An autonomous vehicle comprising:
sensor systems to detect characteristics of an operating environment;
kinematic control systems to provide kinematic controls to the autonomous vehicle;
a vehicle control system coupled with the sensor systems and with the kinematic control systems, the vehicle control system configured to:
operate the autonomous vehicle in a road setting in an operating environment having other road users, wherein the operation of the autonomous vehicle is based, at least in part, on one or more safety constraints providing limits on operation of the autonomous vehicle,
detect the presence of a selected other road user from the other road users within the operating environment,
evaluate one or more potential trajectories for the autonomous vehicle within the operating environment with respect to the selected other road user using at least a cost-based analysis having a machine learned model, wherein the evaluation is based on a hierarchy of costs corresponding to characteristics of maneuvers by the autonomous vehicle, and
cause the autonomous vehicle to interact with the selected other road user by generating vehicle control signals based on cost-based analysis and within the one or more safety constraints.

9. The autonomous vehicle of claim 8, wherein the vehicle control system is further configured to translate yield probabilities between the autonomous vehicle and the other selected road user to costs to be utilized as part of the evaluation of the one or more potential trajectories for the autonomous vehicle within the operating environment with respect to the selected other road user.

10. The autonomous vehicle of claim 8, wherein the other road users comprise one or more of: a human-operated vehicle, another autonomous vehicle, a pedestrian, a bicycle, and a streetcar.

11. The autonomous vehicle of claim 8, wherein the interaction between the autonomous vehicle and the selected other road user comprises a yield/assert decision.

12. The autonomous vehicle of claim 11, wherein a yield probability associated with the yield/assert decision is based on a non-linear relationship between an assert decision by the autonomous vehicle and one or more characteristics of the selected other road user.

13. The autonomous vehicle of claim 8, wherein the evaluation of the one or more potential trajectories for the autonomous vehicle within the operating environment with respect to the selected other road user is performed utilizing a cost-based analysis considering at least safety factors and comfort factors.

14. The autonomous vehicle of claim 13, wherein the comfort factors comprise at least induced kinematic discomfort and post-encroachment time.

15. A system comprising:
a memory system; and
one or more hardware processors coupled with the memory system, the one or more processors configured to:
operate an autonomous vehicle in a road setting in an operating environment having other road users, wherein the operation of the autonomous vehicle is based, at least in part, on one or more safety constraints providing limits on operation of the autonomous vehicle,
detect the presence of a selected other road user from the other road users within the operating environment,
evaluate one or more potential trajectories for the autonomous vehicle within the operating environment with respect to the selected other road user using at least a cost-based analysis having a machine learned model, wherein the evaluation is based on a hierarchy of costs corresponding to characteristics of maneuvers by the autonomous vehicle, and
cause the autonomous vehicle to interact with the selected other road user by generating vehicle control signals based on cost-based analysis and within the one or more safety constraints.

16. The system of claim 15, wherein the one or more hardware processors are further configured to translate yield probabilities between the autonomous vehicle and the other selected road user to costs to be utilized as part of the evaluation of the one or more potential trajectories for the autonomous vehicle within the operating environment with respect to the selected other road user.

17. The system of claim 15, wherein the other road users comprise one or more of: a human-operated vehicle, another autonomous vehicle, a pedestrian, a bicycle, and a streetcar.

18. The system of claim 15, wherein the interaction between the autonomous vehicle and the selected other road user comprises a yield/assert decision.

19. The system of claim 18, wherein a yield probability associated with the yield/assert decision is based on a non-linear relationship between an assert decision by the autonomous vehicle and one or more characteristics of the selected other road user.

20. The system of claim 15, wherein the evaluation of the one or more potential trajectories for the autonomous vehicle within the operating environment with respect to the selected other road user is performed utilizing a cost-based analysis considering at least safety factors and comfort factors.

21. The system of claim 20, wherein the comfort factors comprise at least induced kinematic discomfort and post-encroachment time.
